(19) United States
(12) Patent Application Publication
(10) Pub. No.: US 2019/0127178 A1
(43) Pub. Date: May 2, 2019

(54) ELEVATOR BOARDING AREA NOTIFICATION SYSTEM

(71) Applicant: Mitsubishi Electric Corporation, Chiyoda-ku (JP)

(72) Inventor: Kazuki TSUJI, Tokyo (JP)

(73) Assignee: Mitsubishi Electric Corporation, Chiyoda-ku (JP)

(21) Appl. No.: 16/095,454

(22) PCT Filed: May 9, 2016
(86) PCT No.: PCT/JP2016/063759

§ 371 Date: Oct. 22, 2018

(51) Int. Cl. B66B 3/00; B66B 1/18; B66B 3/02

(52) U.S. Cl. CPC B66B 3/006; B66B 3/02; B66B 1/18

(57) ABSTRACT

An elevator boarding area notification system includes a first read means displaced for each elevator at a boarding area and reads out passenger identification information from a device carried by a passenger; storing a destination floor in relation to the identification information; assigning an elevator car for the destination floor; reading out the identification information at a closer position to the elevator than the first read means reads out; making an agreement decision where the identification information about which assignment was performed by the assigner is read out by a second read means corresponding to the same elevator car, and making a disagreement decision when read out by a second read means corresponding to a different elevator; and making no notification when the first determination means makes an agreement decision, and making a notification of a destination floor and elevator when the first determination means makes a disagreement decision.

### TECHNICAL FIELD

The present invention relates to an elevator boarding area notification system which provides necessary guidance to help a passenger take a right elevator car at a boarding area where multiple elevator cars arrive.

### BACKGROUND ART

For this type of elevator boarding area notification systems, a system has been disclosed (for example, Patent Document 1) which guides passengers by making an announcement such as “The elevator car on the right side is arriving” from a speaker provided at a boarding area.

Also, another elevator boarding area notification system is disclosed (for example, Patent Document 2) which detects the presence/absence of a passenger in front of each elevator boarding area and makes a guiding announcement when an elevator car to be assigned for a passenger is assigned to another elevator car.

### PRIOR ART DOCUMENTS

### Patent Document

Patent Document 1: Japanese Patent Laid-Open Publication No. H9-216776

Patent Document 2: Japanese Patent No. 2548741

### SUMMARY OF THE INVENTION

### Problems to be Solved by the Invention

However, in such an elevator boarding area notification system described above, the system makes a guiding announcement without identifying each passenger; therefore, there has been a problem that a proper announcement cannot be made when another passenger approaches the assigned elevator car.

The present invention is devised to solve the problem above and to provide an elevator boarding area notification system which can guide a passenger to an assigned elevator.

### Means for Solving the Problem

An elevator boarding area notification system of the present invention includes: a read means which is provided for each elevator at an elevator boarding area, reads out identification information from a terminal carried by a passenger and measures reception radio wave intensity; a location determination means to determine the passenger's location from the identification information and the reception radio wave intensity read out by the read means; a terminal information storage means to store correspondence relationship between the identification information and call registration floor information; a registration floor determination means to determine, on the basis of information stored in the terminal information storage means and the identification information read out by the read means, a floor for which a call is to be registered; an elevator assignment means to assign an elevator for a passenger, on the basis of the call-to-be-registered floor determined by the registration floor determination means and the identification information read out by the read means; a call registration means to register to the elevator assigned by the elevator assignment means, a call for the call-to-be-registered floor determined by the registration floor determination means; an arrival determination means to determine whether the passenger has arrived in front of the elevator assigned for the passenger, on the basis of whether or not the passenger has been detected at a location near the elevator assigned for the passenger by the elevator assignment means; a notification floor storage means to store, in a case where a passenger has not arrived in front of an elevator assigned therefor, a destination floor of the passenger; and a notification means to notify the passenger of the floor stored in the notification floor storage means.

### Effects of the Invention

The elevator boarding area notification system notifies by voice of a destination floor from an elevator assigned for a passenger who has not moved in front of the assigned elevator, which thereby gives an effect that elevator boarding area notification system can properly guide the passenger even when another passenger approaches the assigned elevator car.

### BRIEF DESCRIPTION OF THE DRAWINGS

FIG. 1 is an overall configuration diagram of an elevator boarding area notification system according to Embodiment 1 of the present invention.

FIG. 2 is a configuration diagram showing reading operations of reading devices at respective boarding areas of the elevator boarding area notification system according to Embodiment 1 of the present invention.

FIG. 3 are tables in a terminal information storage means 5 of the elevator boarding area notification system according to Embodiment 1 of the present invention.

FIG. 4 are tables in a notification information storage means 8 of the elevator boarding area notification system according to Embodiment 1 of the present invention.

FIG. 5 is a flowchart showing the operation of notification floor update of the elevator boarding area notification system according to Embodiment 1 of the present invention.

FIG. 6 is a flowchart showing an announcement notification operation of the elevator boarding area notification system according to Embodiment 1 of the present invention.

FIG. 7 is a list in notification information storage means 8 of the elevator boarding area notification system according to Embodiment 1 of the present invention, the list being in a state after data addition and designated by Example 1.

FIG. 8 is a list in notification information storage means 8 of the elevator boarding area notification system according to Embodiment 1 of the present invention, the list being in a state after data addition and designated by Example 2.

FIG. 9 is an overall configuration diagram of an elevator boarding area notification system according to Embodiment 2 of the present invention.

FIG. 10 is a flowchart showing an operation of notification floor update of the elevator boarding area notification system according to Embodiment 2 of the present invention.

FIG. 11 is a flowchart showing an operation of notification floor update of the elevator boarding area notification system according to Embodiment 2 of the present invention.

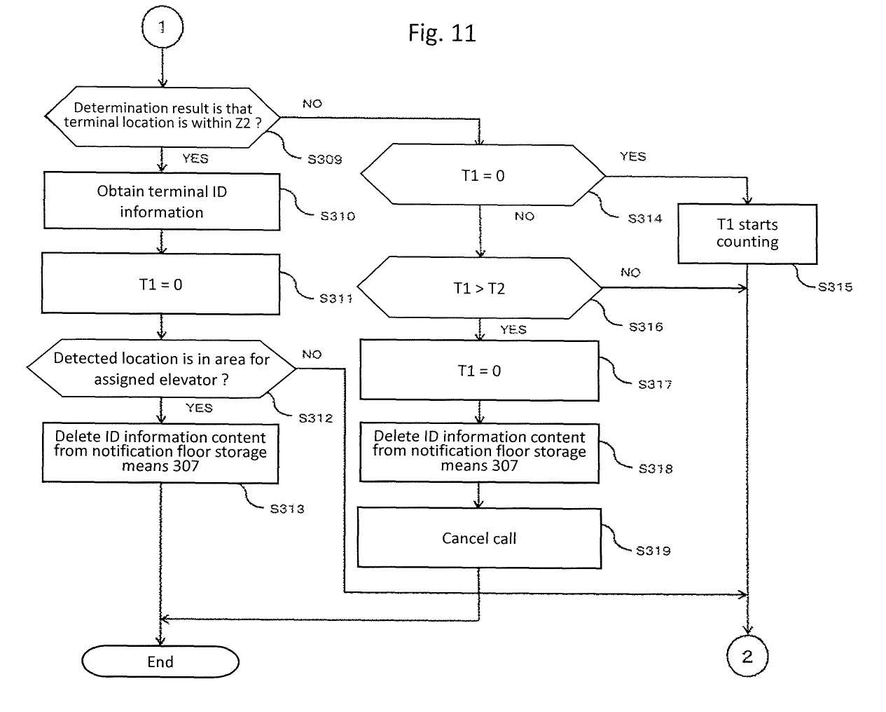

FIG. 12 is an overall configuration diagram showing an elevator boarding area notification system according to Embodiment 3 of the present invention.

FIG. 13 is a flowchart showing an announcement notification operation of an elevator boarding area notification system according to Embodiment 4 of the present invention.

FIG. 14 is a flowchart showing an announcement notification operation of the elevator boarding area notification system according to Embodiment 4 of the present invention.

### EMBODIMENTS FOR CARRYING OUT THE INVENTION

### Embodiment 1

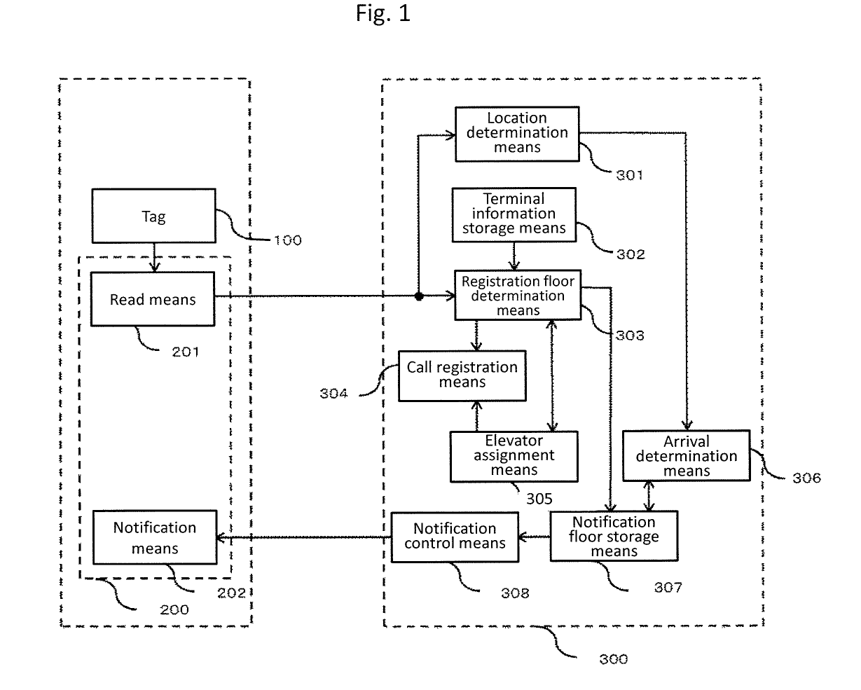

Hereinafter, Embodiment 1 of the present invention will be explained using FIG. 1 to FIG. 8.

FIG. 1 is an overall configuration diagram showing an elevator boarding area notification system according to Embodiment 1 of the present invention.

In the figure, a reference numeral 100 denotes a tag carried by a passenger; a reference numeral 200 denotes an elevator boarding area from which the passenger carrying the tag 100 is to board; and a reference numeral 300 denotes a control device of the elevator.

The tag 100, as generally known, receives an LF signal transmitted from a reading device and transmits unique identification information (hereinafter, referred to as ID information) using an RF signal.

At the elevator boarding area 200, a read means 201 and a notification means 202 are installed for each elevator.

The read means 201 has a function to obtain the ID information from the tag 100 and measure the intensity of radio waves received therefrom.

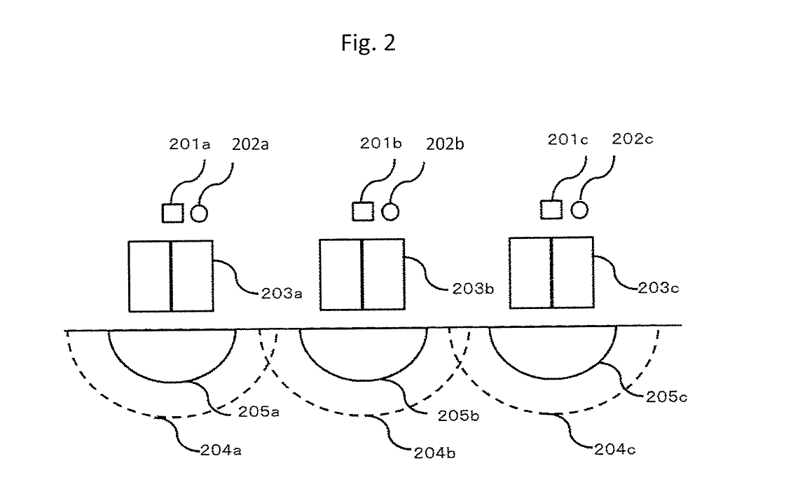

As shown in FIG. 2, the read means 201a, 201b, and 201c are installed above the respective doors of the elevators so that the doors 203a, 203b, and 203c will be positioned at the respective centers of the detection areas.

The notification means 202a, 202b, and 202c give a notification by voice or the like according to the notification information transmitted from a notification control means 308 which will be described later.

An elevator control device 300 includes: a location determination means 301 to determine the location of the tag 100 on the basis of radio wave intensity measured by the read means 201; a terminal information storage means 302 to store, in advance, a registration floor in relation to ID information; a registration floor determination means 303 to determine a registration floor on the basis of the ID information obtained from the read means 201 and floor information obtained from the terminal information storage means 302; a notification floor storage means 307 to store a notification floor; an elevator assignment means 305 to assign an elevator on the basis of the registration floor determined by the registration floor determination means 303; a call registration means 304 to perform call registration on the basis of the elevator assigned by the elevator assignment means 305; an arrival determination means 308 to determine arrival on the basis of the determination result of the location determination means 301; and a notification control means 308 to perform notification control on the basis of the notification floor stored in the notification floor storage means 307.

Here, each of the means 301 to 308 of the elevator control device 300 is configured, for example, with software executed by a microcomputer.

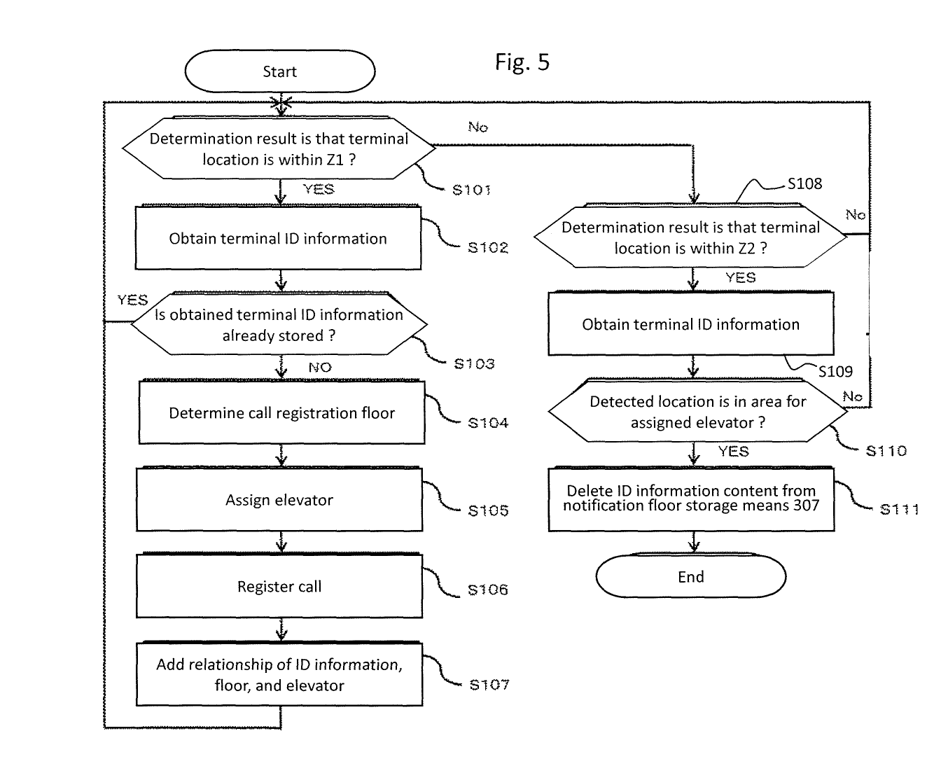

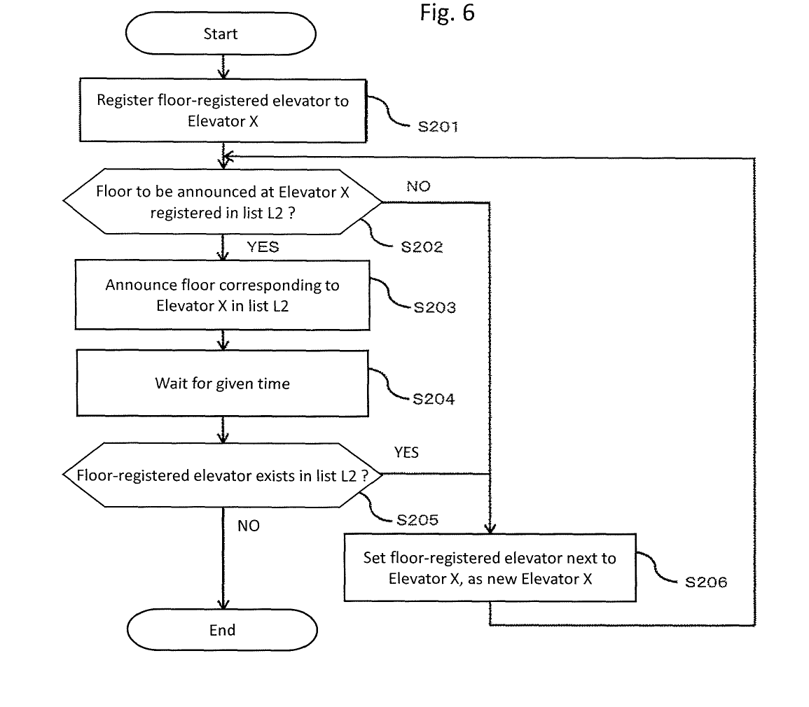

Next, operation will be described using FIGS. 5 to 6.

FIG. 5 is a flowchart showing the operation of notification floor update of the elevator boarding area notification system according to Embodiment 1 of the present invention.

First, radio wave intensity when receiving ID information from the tag 100 is inputted into the location determination means 301 via the read means 201. In S101, on the basis of information on which read means, among the read means 201a, 201b, and 201c, has detected and information obtained on the radio wave intensity measured by each of the read means, the location determination means 301 determines which elevator the tag 100 carried by a passenger is detected at and which detection area the tag is detected in. Here, the location determination means 301 determines whether the passenger-carried tag 100 is located in any one of zones among 204a (hereinafter, referred to as Z1a (Zone 1a)), 204b (hereinafter, referred to as Z1b), and 204c (hereinafter, referred to as Z1c) in FIG. 2 (the zones are collectively referred to as Z1 (Zone 1)). When determining that the tag is in Z1, the process proceeds to S102. And when determining that the tag is not in Z1, the process proceeds to S109. For example, when a passenger P enters Z1a, the process proceeds to S102.

In S102, ID information of the terminal detected by the read means 201 is obtained. “001” is obtained as the ID information of the tag 100 carried by the passenger P, and then, the process proceeds to S103.

In S103, it is determined whether or not the ID information of the tag 100 detected in S102 is already registered in the notification floor storage means 307. If registered, the process proceeds to S101. And if not registered, the process proceeds to S104.

In S104, regarding ID information obtained by the read means 201 of the registration floor determination means 303, a call registration floor corresponding to the same ID information among ID information stored in the terminal information storage means 302, is read out, to be determined as a floor to be registered. Then, the process proceeds to S105.

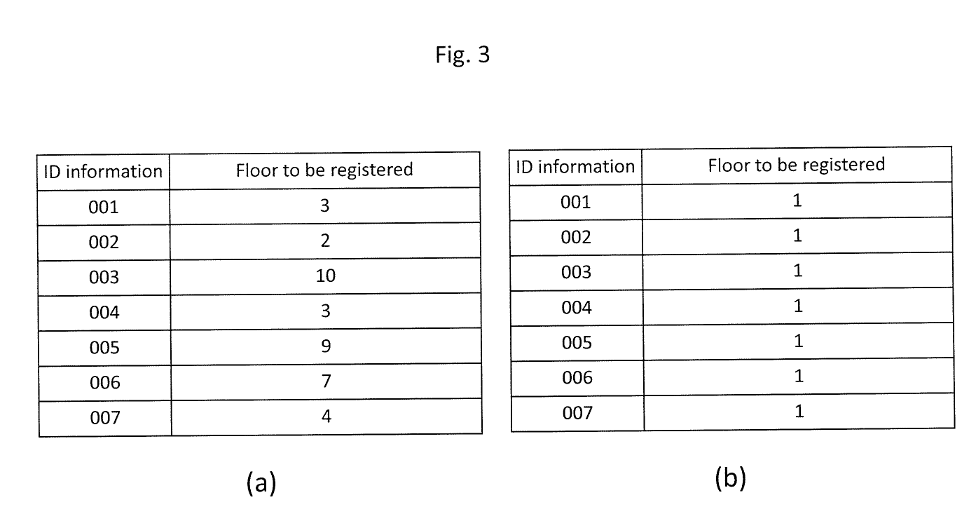

Table contents in the terminal information storage means 302 are shown in FIG. 3.

In a table shown in FIG. 3, the registration floor corresponding to ID information of “001” is “3”, so that it is determined that the registration floor of the passenger P is the 3rd floor.

In S105, the elevator assignment means 305 assigns the call registration floor, which has been determined as “the 3rd floor” in S104, to an elevator and returns the assignment result. Then, the process proceeds to S106. It is assumed here that a call for “the 3rd floor” is assigned to “Elevator B”.

In S106, the call is registered to the elevator assigned in S105, and then, the process proceeds to S107. Here, the call registration means 8 registers the call for “the 3rd floor”, to “Elevator B”.

In S107, the ID information obtained in S102, and information of the floor determined in S104 and the elevator assigned in S105 are added to the notification floor storage means 7, and then the process proceeds to S101.

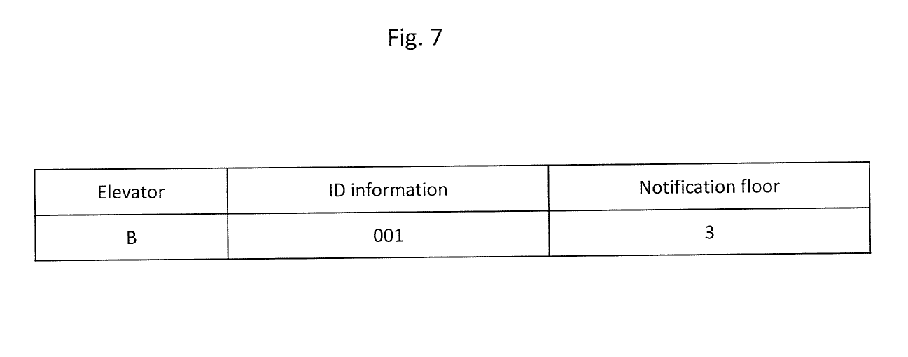

In this example, the ID information is “001”, the floor is “the 3rd floor”, and the assigned elevator is “Elevator B”; these pieces of information are registered into a list L2. FIG. 7 is a list designated by Example 1 in the notification information storage means 308, the list being in a state after data addition.

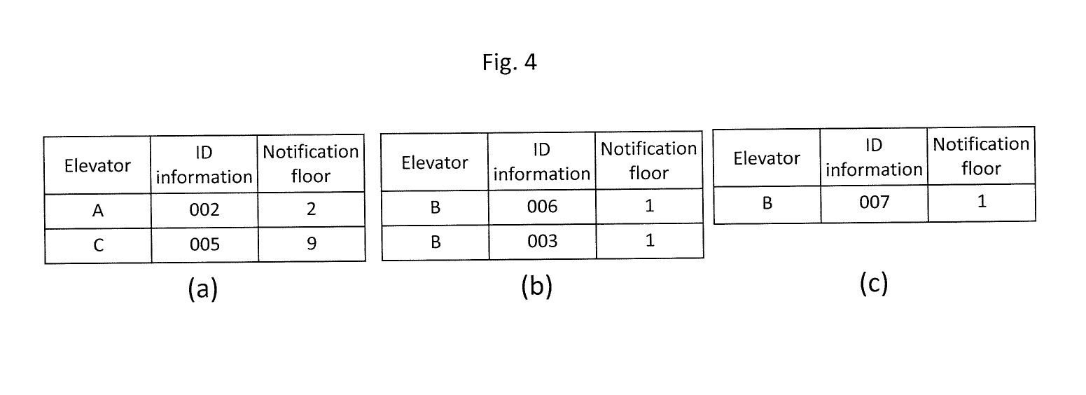

The notification floor storage means 7 stores the list L2 in which a notification floor is related with an elevator where notification is made. Examples of the list L2 are shown in FIG. 4. There exists a list L2 for each floor.

During a period when the passenger P is kept detected in Z1 after determining which elevator is assigned for the floor determined by the registration floor determination means 6, S103 determines that the ID information of the tag 100 of the passenger P has been registered in the list L2 of the notification information storage means 307; therefore, the elevator assignment means 305 repeats from S101 to S103.

Steps of S108 to S111 are a flow to detect if a passenger has moved, for example in FIG. 2, from 204b (Z1b) to 205b (hereinafter, referred to as Z2b (Zone 2b)). In addition, the same goes for 205a (hereinafter, referred to as Z2a) and 205c (hereinafter, referred to as Z2c), and these zones are collectively referred to as Z2 (Zone 2).

In S108, the location determination means 301 determines, on the basis of the radio wave intensity at the read means 201, whether or not the position of the tag 100 carried by the passenger is within Z2. If determined within Z2, the process proceeds to S109, and if not within Z2, the process proceeds to S101.

In S109, the ID information detected by the read means 201 is read out, and the process proceeds to S110. It is assumed here that the ID information of the tag carried by the passenger P is “001”.

In S110, on the basis of which read means has read out the ID information of the tag 100 among the read means 201a, 201b, and 201c, the location determination means 301 determines whether or not the read-out detection has been made at the location of the assigned elevator. If the read-out location is the location of the assigned elevator, the process proceeds to S111; and if the read-out location is not the location of the assigned elevator, the process proceeds to S101.

In this example, the assigned elevator is “Elevator B”; therefore, if the ID information is read out by the read means 201b, the process proceeds to S111.

In S111, the arrival determination means 306 determines that the passenger P has arrived in front of the assigned elevator, to delete the ID information, the call registration floor, and the assigned elevator from the notification information storage means 307. In this example, the ID information of “001”, the call registration floor of “the 3rd floor”, and the assigned elevator of “Elevator B” are deleted from the list L2.

Next, a notifying operation will be explained using FIG. 6.

FIG. 6 is a flowchart showing an announcement notification operation of the elevator boarding area notification system according to Embodiment 1 of the present invention.

In S201, a newly registered elevator is set to Elevator X, and then the process proceeds to S202.

Here, a floor has been assigned to “Elevator B”, so that “Elevator B” is set.

In S202, it is determined whether a floor to be announced at Elevator X is registered in the notification floor storage means 307 (list 2). If the floor to be announced is registered, the process proceeds to S203; and if the floor to be announced is not registered, the process proceeds to S206.

In this example, because the floor to be announced is registered to “Elevator B”, the process proceeds to S203.

In S203, the notification control means 308 instructs the notification means 202 to notify of an elevator and a floor to be announced, which correspond to Elevator X and a floor in the list L2 to be notified of; and then, the notification means 202 makes the notification, and the process proceeds to S204. In this example, because in the list L2, “the 3rd floor” is registered with “Elevator B”, the notification means 202b of “Elevator B” announces that “This elevator will stop at the 3rd floor”.

In S204, the process waits for a given interval, to proceed to S205. Because the waiting time in S204 serves as the repetition cycle of the notification announcement, the announcement frequency (for example, 10 seconds) is set so that the announcement will be easy for the passengers to hear and will not become harsh therefor.

In S205, it is determined whether a floor is registered in the list L2; and then the process proceeds to S206.

In S206, the elevator next to Elevator X is newly chosen as Elevator X.

In this example, only “the 3rd floor” is registered to “Elevator B”; therefore, the notification announcement of “the 3rd floor” at “Elevator B” is to be repeated until the passenger arrives in front of “Elevator B”.

Next, another example will be shown in which, in a situation where the lists L2 have been already registered as shown in FIG. 4, a passenger Q carrying a tag 100 with an ID of “004” is detected near Elevator B at the 1st floor and is assigned to Elevator C. It is assumed that the initial states of lists L1 are shown in FIG. 3.

Under the conditions described above, explanation will be made below about an operation example according to a notification floor update flow shown in FIG. 5.

When the passenger Q enters Z1b, S101 detects the terminal thereof, and then the process proceeds to S102.

S102 obtains the ID information of “004” of the terminal for the passenger Q which is detected by the terminal information obtaining means 302, and the process proceeds to S103.

Because the ID information has not been registered in the list L2, the operation of S104 and operations thereafter such as elevator assignment and call registration are performed.

In S104, on the basis of the ID information obtained from the read means 201, the registration floor determination means 303 determines the call registration floor from the terminal information storage means 302, and then, the process proceeds to S105. In this example, the ID information of the tag carried by the passenger P is “004”; therefore, from the content of the list L1 stored in the terminal information storage means 302, it is determined that the call registration floor is “the 3rd floor”.

In S005, the elevator assignment means 305 assigns the call registration floor determined as “the 3rd floor” in S004, to an elevator. In this example, it is assumed that “the 3rd floor”, i.e. a floor to be registered upon a call, is assigned to Elevator C.

In S106, the call registration means 304 registers a call for “the 3rd floor”, i.e. a call registration floor, to Elevator C assigned in S105.

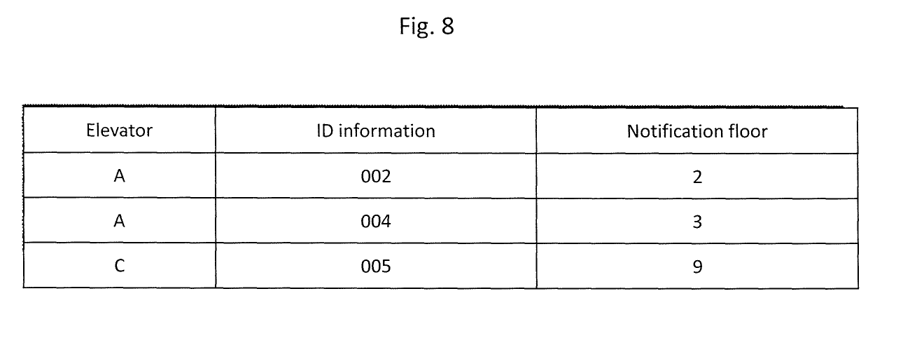

S107 registers an information combination of the ID information of “004”, the floor of “the 3rd floor”, and the assigned elevator of “Elevator A”, in the list L2. The list L2 with the information combination having being added is shown in FIG. 8.

The steps of S101 to S103 are repeated until it is determined in S108 that the passenger Q has entered Z2.

In S109, an ID information of “004” is obtained, which is the ID information of a terminal for the passenger Q detected by the read means 201.

In S110, the passenger Q is detected in Z2c, i.e. an area near Elevator C to which the passenger Q is assigned; and then, the process proceeds to S111.

S111 deletes the information combination of the ID information of “004”, the assigned elevator of “Elevator C”, and the call-registered floor of “the 3rd floor”, from the list L2 of the notification floor storage means 7 shown in the figure.

Next, the notification operation shown in FIG. 6 will be explained below.

The notification operation will be explained in a state in which the notification floor update operation has been completed as shown in FIG. 8.

Explanation will be begun from S202 in a state where “Elevator B” is registered as Elevator X.

In S202, the process proceeds to S206 because a floor to be announced at “Elevator B” is not, registered at this time.

In S206, “Elevator C” is chosen as the next Elevator X because the current Elevator X is “Elevator B”.

In S202, the process proceeds to S203 because a floor to be announced is registered to “Elevator C”.

Because “the 9th floor” is registered to “Elevator C”, an announcement that “this elevator will stop at the ninth floor” is made in S203.

In S204, the process waits for a given interval.

In S205, the process proceeds to S206 because there are elevators registered on the list L2.

In S506, “Elevator A” is chosen as the next Elevator X because the current Elevator X is Elevator C.

Because a floor to be announced is registered to “Elevator A”, the process in S202 proceeds to S203.

Because “the 2nd floor” and “the 3rd floor” are registered to “Elevator A”, an announcement that “this elevator will stop at “the 2nd floor” and “the 3rd floor” is made in S203. Here, even if a same floor is registered multiple times to a specific elevator, multiple announcements are not made on the same floor.

As described above, announcements are made in order until all the passengers arrive in front of their respective elevators registered on the list L2 and all floors to be announced are removed from the list.

In this invention, the elevator boarding area notification system according to the present embodiment notifies, by voice, of the destination floor from an elevator assigned to a passenger having not arrived in front thereof, thereby appropriately guiding the passenger even when another passenger approaches the assigned elevator car.

In the present embodiment, the read means 201 has a function to read the identification signal from the tag 100 and a function to measure the radio wave intensity from the tag 100, realizing a read means by a single device. This brings an effect in reducing the size of the elevator boarding area notification system.

In the present embodiment, a case has been explained in which the tag 100 is used as a terminal; however, an information transmitting device may be used instead of the tag 100. For example, the function of the tag may be installed to a mobile phone or a smart phone. This can produce the same effect as explained in the present embodiment.

Furthermore, in that case, the display of the mobile phone or the smart phone may be used as the notification means 202 of the elevator boarding area, producing the same effect as explained in the present embodiment.

In this embodiment, it was explained that the read means 201 has a function to read an identification signal from the tag 100 and a function to measure the radio wave intensity from the tag 100. However, the read means may be separated into individual functions to be realized as a read means and a power measurement means.

It was also explained in this embodiment that the read means 201 has a function to read an identification signal from the tag 100 and a function to measure the radio wave intensity from the tag 100. However, the read means is disposed at the boarding area for each elevator car and may be configured with a first read means to read out identification information from the information transmitting device carried by an elevator passenger, and a second read means which is disposed near the first read means and reads out the identification information of the passenger at a closer position to the each elevator car than the first read means reads out.

This configuration need not measure the radio wave intensity from the information transmitting devices, bringing an effect of reducing the size of the elevator boarding area notification system.

### Embodiment 2

In Embodiment 1, it was explained that notification is made when a passenger approaches a door of an elevator. However, a configuration may be possible in which notification is cancelled when it is determined that the passenger has moved away from the door. Such a configuration will be explained below. Hereinafter, what has already been explained in Embodiment 1 will be appropriately omitted.

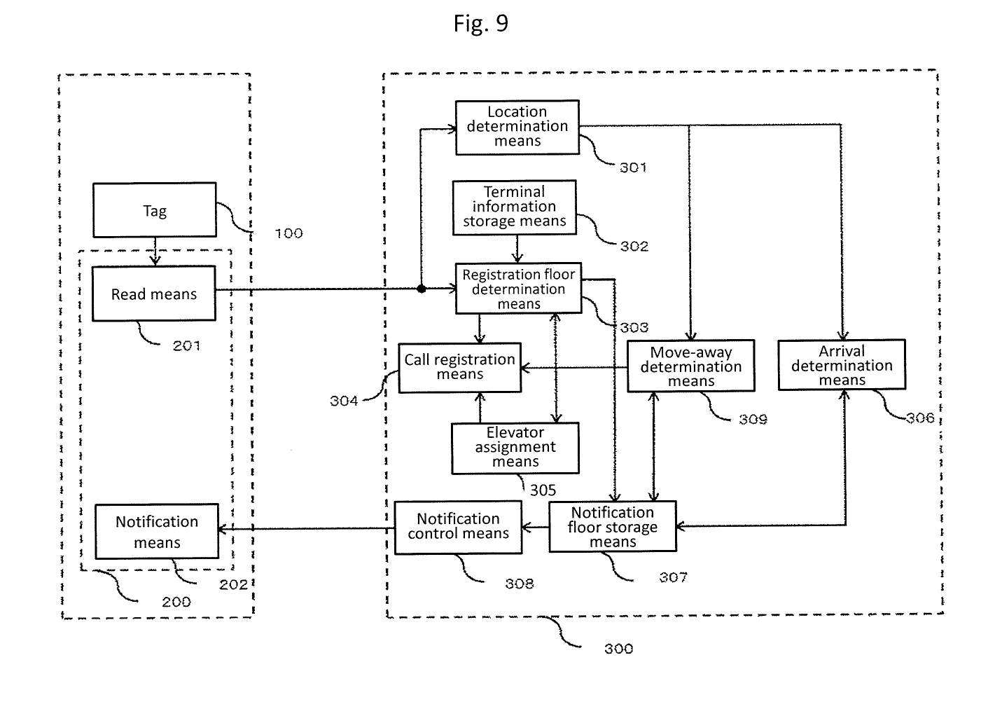

FIG. 9 shows an overall configuration diagram of an elevator boarding area notification system according to Embodiment 2 of the present invention.

The numeral 309 denotes a move-away determination means which determines, when a passenger, for whom an elevator to board and the destination floor are already registered, has not been detected for a given time in both areas of an area Z1 for performing call registration and an area Z2 for determining arrival, that the passenger has moved away from the boarding area.

Next, the operation will be explained.

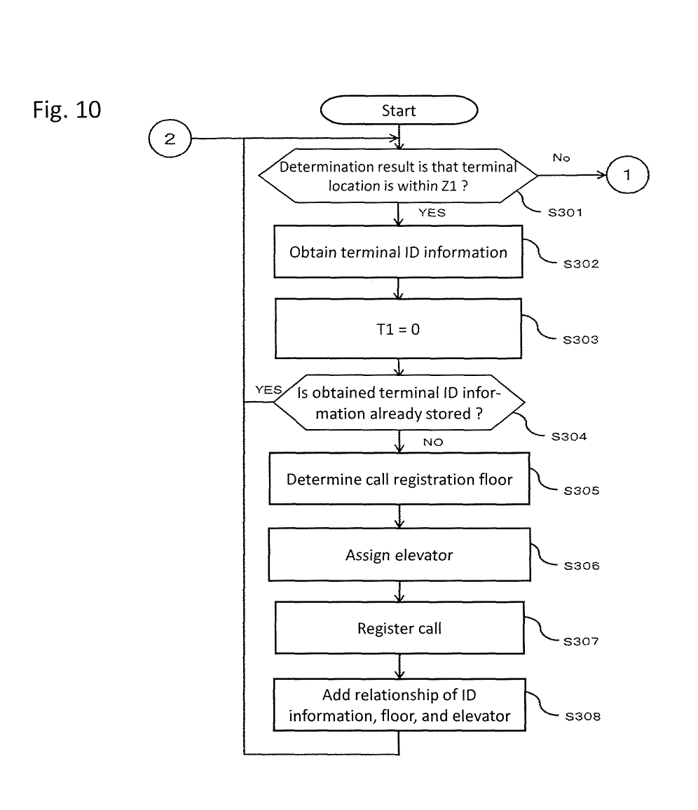

FIG. 10 shows an operation flowchart of the elevator boarding area notification system according to Embodiment 2 of the present invention.

In the present embodiment, the move-away determination means 309 uses two kinds of count values of T1 and T2 to determine whether a passenger moves away from the boarding area. When detected in Z1, T1 starts counting, for example in seconds. And when detected in Z2, T1 is reset to “0”.

T2 is a count value for determining whether the passenger has moved away from the boarding area after once detected in Z1 or Z2; for example, 5 seconds is set to T2.

S301 and S302 have been explained in Embodiment 1, so their explanations will be omitted here.

In S303, because the passenger is detected in Z1, the count operation is stopped to set “0” to T1. Then, the process proceeds to S304.

S304 to S308 have been described in Embodiment 1 and their explanation will be omitted.

In S309, the location determination means 301 determines whether the position of the tag 100 is within Z2. If within Z2, the process proceeds to S310, and if not within Z2, the process proceeds to S314.

S310 was previously explained in Embodiment 1, therefore its explanation will be omitted.

In S311, because the passenger is detected within Z2, the count operation is stopped to set “0” to T1. Then the process proceeds to S312.

In S312, it is determined whether or not the elapsed time T1 is “0”, in other words, if the counting has already started. If T1=0, i.e. the count operation has not been started, the process proceeds to S315. If T1≠0, i.e. the count operation has been started, the process proceeds to S316.

In S315, the count operation of T1 is started. From this time forward, T1 holds the time elapsed from when the count operation was started.

In S316, the move-away determination means 309 determines whether T1>T2. When T1>T2 does not hold, the predetermined time period T2 has not been elapsed yet, therefore, the process returns to S301 to repeat steps S301 to S315. When T1>T2 holds, it is determined that the passenger has moved away from Z1 and Z2, and then, the process proceeds to S317.

In S317, the count operation of T1 is stopped and a setting operation of T1=0 is performed. Then the process proceeds to S318.

In S318, the information corresponding to the identification information previously obtained in S310 is deleted from the list L2 of the notification floor storage means 307. Then the process proceeds to S319. From this time forward, no announcement will be made according to notification floor information having been call-registered by a passenger for whom it, is determined that the passenger has moved away from the boarding area.

In S319, the call registration means 304 cancels the call corresponding to the identification information obtained in S309. Then, the process returns to S301.

In Embodiment 2, the move-away determination means 307 is provided; and when T2 elapses after the passenger is detected in Z1 and Z2, the move-away determination means determines that the passenger has moved away from the boarding area. In such a case, this refrains from notifying of the destination, reducing useless calls.

### Embodiment 3

In Embodiments 1 and 2, the configurations have been explained in which a notification is made when a passenger approaches an elevator door, and the notification is cancelled when determining that the passenger has moved away an area near the elevator door. Furthermore, when a passenger mistakes the elevator, a notification therefor may be prioritized over other notification contents. Such a configuration will be explained below.

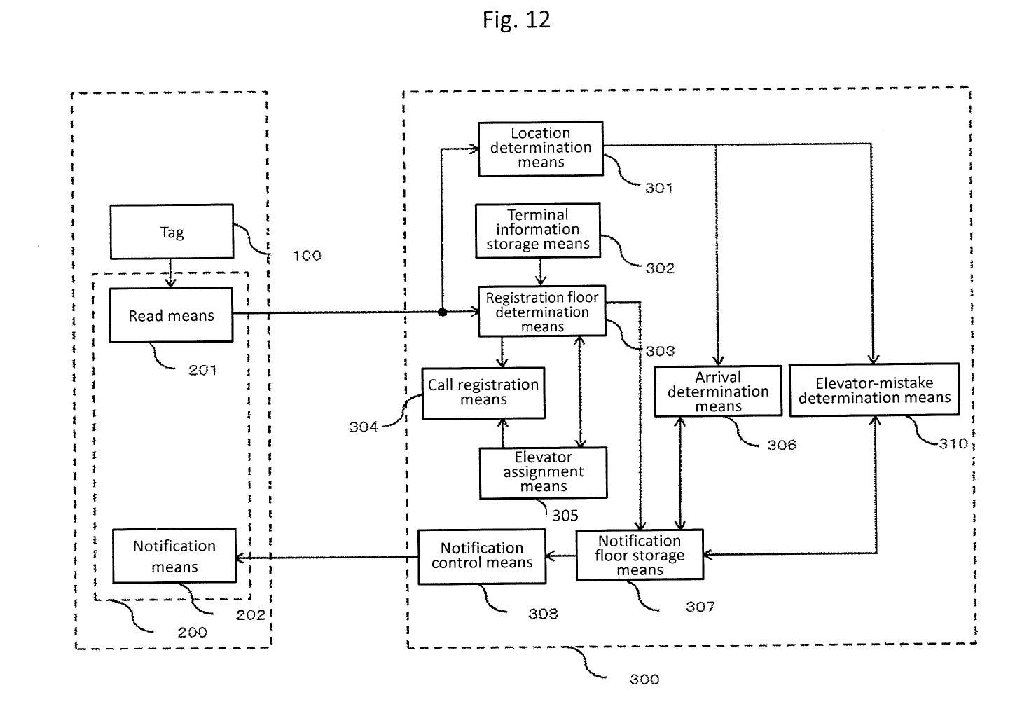

Hereinafter, Embodiment 3 of the present invention will be explained using FIG. 12 to FIG. 14. With respect to the parts previously explained in Embodiment 1 or 2, their explanations will be appropriately omitted below.

FIG. 12 is an overall configuration diagram showing an elevator boarding area notification system according to Embodiment 3 of the present invention.

In FIG. 12, an elevator-mistake determination means 310 is further added to the overall configuration diagram shown in FIG. 1 which is the diagram of the elevator boarding area notification system according to Embodiment 1.

When a passenger for whom an elevator to board and a destination floor are already registered, is detected for a given time in Z2 of an elevator other than the elevator assigned to the passenger, the elevator-mistake determination means 310 determines that the passenger moves away from a boarding area.

In the present embodiment, the elevator-mistake determination means 310 uses two kinds of count values of T3 and T4, to determine whether mistaking an elevator, on the basis of whether a passenger is waiting in front of an elevator assigned for the passenger. T3 is elapsed time measured while a passenger is away; it counts up, for example in seconds. The initial value of T3 is “0”. T4 is reference time for determining, when T3>T4, that the passenger has mistaken an assigned elevator. For example, 10 seconds is set to T4.

When the elevator-mistake determination means 310 determines that the passenger has mistaken an elevator, an announcement is made again from the elevator to which the passenger is assigned.

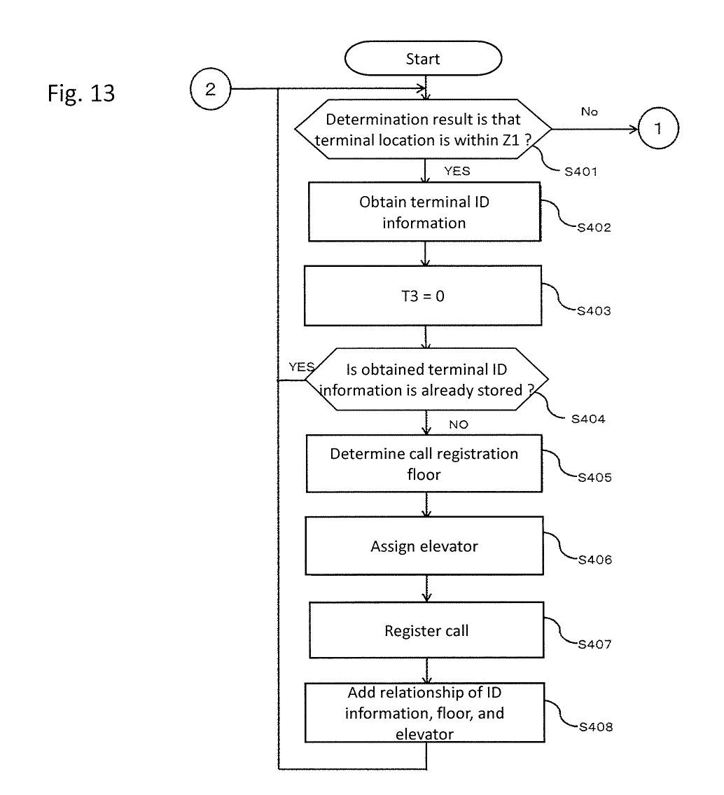

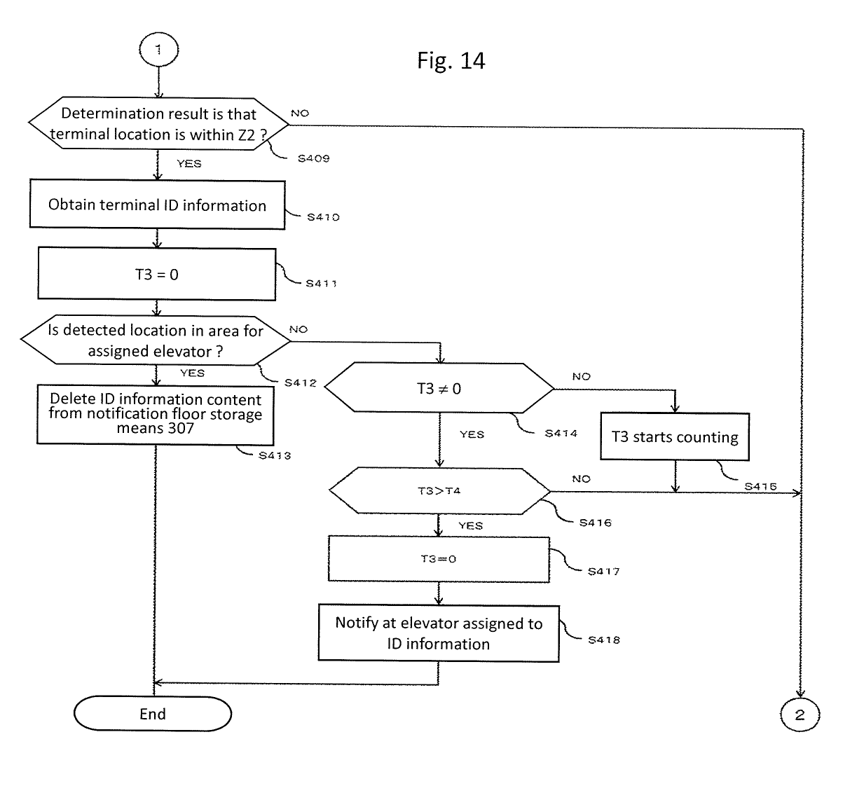

Next, the operation will be explained using FIGS. 13 and 14.

FIGS. 13 and 14 are flowcharts showing a notification floor update operation of the elevator boarding area notification system according to Embodiment 3 of the present invention.

S401 and S402 were previously explained in Embodiment 1; therefore, their explanations will be omitted.

In S403, because the passenger is detected in Z1, the count operation is stopped to set “0” to T3. Then, the process proceeds to S304.

S404 to S408 were previously explained in Embodiment 1; therefore, their explanations will be omitted.

S409 and S410 were previously explained in Embodiment 1; therefore, their explanations will be omitted.

In S411, because the passenger is detected in Z2, the count operation is stopped to set “0” to T3. Then, the process proceeds to S412.

In S412, when the location of the tag 100 carried by the passenger detected by the location determination means 301 is in an area of the assigned elevator, the process proceeds to S413; and when not in the area of the assigned elevator, the process proceeds to S414.

In S413, because the location determination means 301 determines that the passenger is detected in front of the elevator assigned to the passenger, it is determined that guidance is unnecessary. And then, the information corresponding to the identification information obtained in S410 is deleted from the list L2 of the notification floor storage means 307 to end the process.

The steps of and after S414 are processes to be performed in a state where the passenger is detected in front of an elevator other than an elevator assigned to the passenger.

In S414, it is determined whether or not the elapsed time T3 is “0”, in other words, if the counting has already started. If T3=0, i.e. the count operation has not been started, the process proceeds to S415. If T3≠0, i.e. the count operation has been started, the process proceeds to S416.

In S415, the count operation of T3 is started. From this time forward, T3 contains the time elapsed from when the count operation was started.

In S416, the elevator-mistake determination means 310 determines whether T3>T4. If T3>T4, the process proceeds to S417; and if not T3>T4, the process returns to S401.

In S417, a setting operation of T3=0 is performed to stop the count operation. Then, the process proceeds to S418.

In S418, a notification is made again by the notification control means 308 at the elevator assigned to the identification information detected in S410.

In the embodiment, when a passenger is detected for a given time (for example 10 seconds) in front of an elevator other than an elevator assigned therefor, the elevator notification system according to the present invention notifies of mistaking an elevator. This brings an effect in that a passenger staying in front of a wrong elevator car can be prevented from boarding by mistake.

In this embodiment, only when an elevator car assigned to a passenger is different from an elevator car of an area where identification information of an information transmitting device carried by the passenger has been read out, guidance is performed about the destination floor and the elevator car; therefore, necessary notification can be made when the passenger stays in front of a wrong elevator car. And no notification is made for passengers staying in their correct elevator car boarding area, which brings an effect in that useless notification is not made.

In the embodiment described above, notification is to be made under a condition when detecting for a predetermined time, which further brings an effect in that a reliable notification can be made for a passenger waiting in front of an elevator different from that assigned therefor.

In Embodiment 3, explanation has been made separately with respect to the location determination means 301, the arrival determination means 306, and the elevator-mistake determination means 310; alternatively, a first determination means may be provided, which makes an agreement decision in a case where passenger identification information about which assignment was performed by the assignment means is read out by a second read means corresponding to the same elevator car as assigned, and makes a disagreement decision in a case where being read out by a second read means corresponding to an elevator car different from the assigned elevator car. In this case, as described in Embodiment 1, the first read means is disposed for each elevator car at the boarding area to read out identification information from the information transmitting device carried by an elevator passenger; the second read means is disposed near the first, read means to read out, the identification information of the passenger at a closer position to the each elevator car than the first read means reads out.

And if the notification means does not notify when the first determination means has made an agreement decision, and notifies of the destination floor and the elevator car when having made a disagreement decision, a voice notification of the destination floor is to be made from the assigned elevator in front of which the passenger has not moved. This brings an effect in that even when another passenger approaches the assigned elevator car, an appropriate guidance is made.

The configurations described in Embodiments 1 to 3 are just examples and do not exclude other realization methods.

Also, the configurations described in Embodiments 1 to 3 may be properly combined, and a part thereof may be omitted.

### INDUSTRIAL APPLICABILITY

The present invention can be applied to elevator control devices.

### DESCRIPTION OF SYMBOLS

100: tag
200: elevator car
201: read means
2022: notification means
300: elevator control device
301: location determination means
302: terminal information storage means
303: registration floor determination means
304: call registration means
305: elevator assignment means
306: arrival determination means
307: notification floor storage means
308: notification control means
309: move-away determination means
310: elevator-mistake determination means

1.-6 (canceled)

7. An elevator boarding area notification system, comprising:
a reader which is provided for each elevator at an elevator boarding area, reads out identification information from a terminal carried by a passenger and measures reception radio wave intensity;
a location determiner to determine the passenger's location from the identification information and the reception radio wave intensity read out by the reader;
a terminal information storage to store correspondence relationship between the identification information and call registration floor information;
a registration floor determiner to determine, on the basis of information stored in the terminal information storage and the identification information read out by the reader, a floor for which a call is to be registered;
an elevator assignor to assign an elevator for a passenger, on the basis of the call-to-be-registered floor determined by the registration floor determiner and the identification information read out by the reader;
a call register to register to the elevator assigned by the elevator assignor, a call for the call-to-be-registered floor determined by the registration floor determiner;
an arrival determiner to determine whether the passenger has arrived in front of the elevator assigned for the passenger, on the basis of whether or not the passenger has been detected at a location near the elevator assigned for the passenger by the elevator assignor;
a notification floor storage to store, in a case where a passenger has not arrived in front of an elevator assigned therefor, a destination floor of the passenger; and
a notifier to notify the passenger of the floor stored in the notification floor storage.

8. The elevator boarding area notification system according to claim 7, further comprising:
a move-away determiner to determine, on the basis that a passenger for whom an elevator was assigned has not been detected for a given time within an area for call registration, that the passenger has moved away from the boarding area and to cancel a notification of the passenger's destination floor of the assigned elevator.

9. The elevator boarding area notification system according to claim 7, further comprising:
an elevator-mistake determiner to determine, on the basis of whether or not a passenger to whom an elevator was assigned has been detected for a given time in front of an elevator other than an elevator assigned therefor, that the passenger mistakes the assigned elevator; and
a notification controller to make, when it is determined that the passenger mistakes the assigned elevator, a prioritized voice notification of the destination floor of the elevator assigned for the passenger.

10. The elevator boarding area notification system according to claim 8, further comprising:
an elevator-mistake determiner to determine, on the basis of whether or not a passenger to whom an elevator was assigned has been detected for a given time in front of an elevator other than an elevator assigned therefor, that the passenger mistakes the assigned elevator; and
a notification controller to make, when it is determined that the passenger mistakes the assigned elevator, a prioritized voice notification of the destination floor of the elevator assigned for the passenger.

11. An elevator boarding area notification system, comprising:
a first reader which is displaced for each elevator car at a boarding area and reads out passenger identification information from an information transmitting device carried by an elevator passenger;
a terminal information storage to store, in advance, a destination floor in relation to the passenger identification information;
an assignor to assign, from among plural elevator cars, an elevator car for the destination floor;
a second reader which is disposed near the first reader and reads out the identification information of the passenger at a closer position to the elevator than the first reader reads out;
a first determiner
to make an agreement decision in a case where the passenger identification information about which assignment was performed by the assignor is read out by a second reader corresponding to the same elevator car as the assigned elevator car, and
to make a disagreement decision in a case where being read out by a second reader corresponding to an elevator car different from the assigned elevator car; and
a notification controller to control to make no notification when the first determiner makes an agreement decision, and to make a notification of a destination floor and an elevator car when the first determiner makes a disagreement decision.

12. The elevator boarding area notification system according to claim 11, wherein the second reader uses the first reader to read out the identification information of the passenger at a closer position to the elevator on the basis of reception power transmitted from the information transmitting device.

13. The elevator boarding area notification system according to claim 11, further comprising
a second determiner to compare an elevator car corresponding to an area read out by the first reader with an elevator car corresponding to an area read out by the second reader,
wherein the notification controller controls to make a notification when a condition is detected for a predetermined time in which the second determiner makes an agreement decision and the first determiner makes a disagreement decision.

14. The elevator boarding area notification system according to claim 12, further comprising
a second determiner to compare an elevator car corresponding to an area read out by the first reader with an elevator car corresponding to an area read out by the second reader,
wherein the notification controller controls to make a notification when a condition is detected for a predetermined time in which the second determiner makes an agreement decision and the first determiner makes a disagreement decision.
